(19) United States
(12) Patent Application Publication
(10) Pub. No.: US 2008/0320126 A1
(43) Pub. Date: Dec. 25, 2008

(54) ENVIRONMENT SENSING FOR INTERACTIVE ENTERTAINMENT

(75) Inventors: Steven Drucker, Bellevue, WA (US); James E. Allard, Seattle, WA (US); David Sebastien Alles, Seattle, WA (US); James C. Finger, Kirkland, WA (US); Todd E. Holmdahl, Redmond, WA (US); Oliver R. Roup, Seattle, WA (US); David H. Sloo, Menlo Park, CA (US); Dawson Yee, Bellevue, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/767,731

(22) Filed: Jun. 25, 2007

(51) Int. Cl. G06F 15/173

(52) U.S. Cl. 709/224

(57) ABSTRACT

The claimed subject matter relates to an architecture that can facilitate an enhanced entertainment experience based upon interactivity between entertainment medium or content and a content consumer's environment. In one aspect, based upon features or condition of a content consumer's environment, entertainment content can be interactively selected or modified. In another aspect, based upon features included in the entertainment content, components or conditions extant in the environment can be interactively updated or modified.

### CROSS-REFERENCE TO RELATED APPLICATIONS

This application is related to co-pending U.S. patent application Ser. No. (MSFTP1800US) ______, entitled “MINING IMPLICIT BEHAVIOR”, and is also related to co-pending U.S. patent application Ser. No. (MSFTP1805US) ______, entitled “AUTOMATIC CONFIGURATION OF DEVICES BASED ON BIOMETRIC DATA”, both of which are being filed concurrently. The entireties of these applications are incorporated herein by reference.

### BACKGROUND

Conventionally, certain forms of entertainment such as movies or games are prepackaged and include very little in the way of interactive experiences. While movie producers or other content authors always strive to reach the audience in unique ways, it is typically not possible to provide elements such as interactive story lines, setting, moods, etc. based upon one particular viewer at one particular time or based upon a particular viewer's (potentially unique) environment.

Likewise, book authors or publishers are faced with similar difficulties wherein moods or other effects desired by the content author are constrained entirely by the type of entertainment or the medium by which that entertainment is propagated to the content consumer. In some cases books can include a simple “choose-your-own-adventure” scenario, whereby the content consumer may be exposed to semi-tailored content. However, the selection of the content is a result of a conscious choice and on behalf of and direct input by the content consumer, leaving realms of potential interaction unexplored.

Similarly, in other forms of entertainment such as video games, the extent of interactivity is essentially a personification of the “choose-your-own adventure” scenario. While the gamer may have total control over the actions associated with the gaming interface (e.g., controlling a character or vehicle, choosing buildings to construct, selecting a category . . . ), all variable content selection is a direct result of the gamer's actions or behavior within the game. No mechanism exists for sensing a gamer's environment and, based upon these readings, dynamically tailor content.

Moreover, no mechanism exists for utilizing the content consumers environment to enhance the entertainment content. Movie producers, book publishers, game developers and other entertainment content authors have long desired the ability to at least figuratively step into a content consumer's living room, however, no conventional means exist for doing so.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can facilitate an enhanced entertainment experience based upon interactivity between an entertainment medium (or entertainment content) and an environment. According to one aspect, the architecture can include components to interface or communicate with an entertainment medium (e.g., a video game or television), as well as to examine, diagnose, or analyze the entertainment content.

The architecture can also include components to detect or obtain environment variables such as biometrics of a content consumer, responses to particular stimuli, a count of content consumers, ambient environment conditions such as sound, lighting, temperature or the like, as well as many other environment variables. Based upon the various inputs, the architecture (or components thereof) can dynamically determine interactive settings, which can be applied to one or more of the entertainment medium, the entertainment content, or other devices or components extant in the content consumer's environment to, e.g. enhance, augment, or enrich an entertainment experience.

Accordingly, it is to be appreciated entertainment content can be created such that the content is interactively responsive to conditions that exist in the content consumer's environment (e.g., providing a different ending based upon conditions of a content consumer's environment). Additionally or alternatively, entertainment content can be created or designed to potentially employ components extant in a content consumer's environment to facilitate or enhance intended features, moods, or effects (e.g., subtly dimming the lights prior to a particular scene or sequence). In accordance therewith, entertainment content authors need no longer be constrained by conventional limitations of content effects and delivery, but can explore new frontiers of interactive entertainment.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a system that can facilitate an enhanced entertainment experience based upon interactivity between an entertainment medium and an environment.

FIG. 2 illustrates a block diagram of a system that can update the entertainment medium to facilitate an enhanced entertainment experience.

FIG. 3 depicts a block diagram of a system that can monitor and update the environment to facilitate an enhanced entertainment experience.

FIG. 4 is a graphical representation of various exemplary environment variables.

FIG. 5 illustrates a block diagram an example environment that relates to consumption of entertainment content.

FIG. 6 depicts a block diagram of a system that illustrates exemplary relationships and/or information paths.

FIG. 7 is an exemplary flow chart of procedures that define a method for facilitating an enhanced entertainment experience based upon interactivity between an entertainment medium and an environment.

FIG. 8 illustrates an exemplary flow chart of procedures that define a method for applying an interactive setting employed for facilitating an enhanced entertainment experience.

FIG. 9 illustrates an exemplary flow chart of procedures that define a method for inferring interactive settings employed for facilitating an enhanced entertainment experience.

FIG. 10 illustrates a block diagram of a computer operable to execute the disclosed architecture.

FIG. 11 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

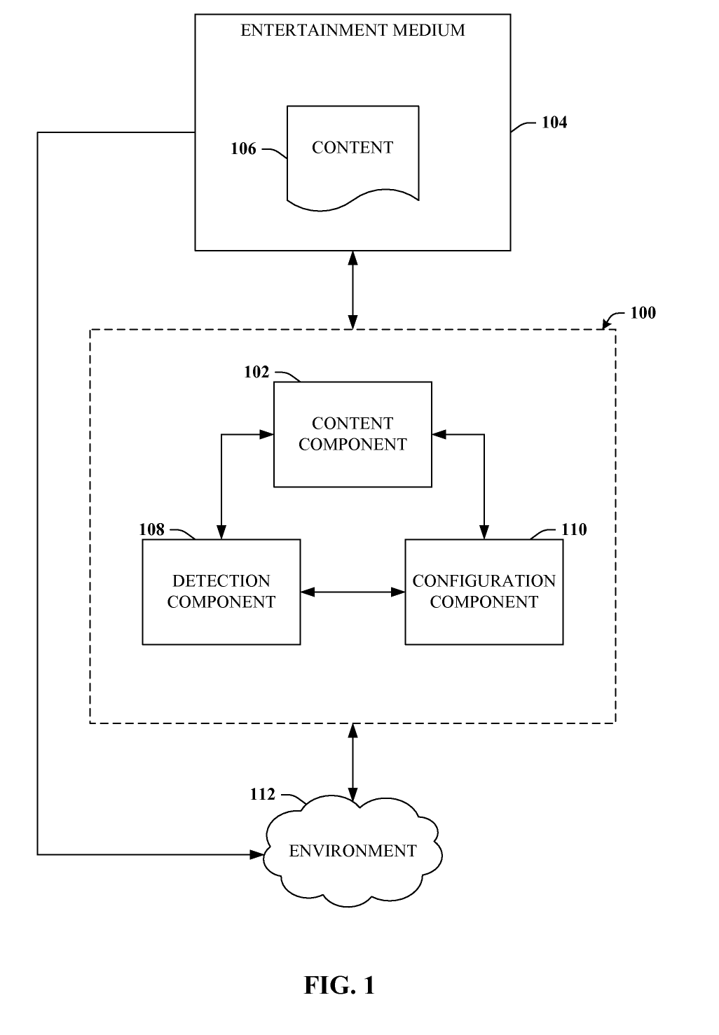

Referring now to the drawings, with reference initially to FIG. 1, a system 100 that can facilitate an enhanced entertainment experience based upon, e.g. interactivity between an entertainment medium and an environment is depicted. Generally, the system 100 can include a content component 102 that can communicate with an entertainment medium 104. For example, the content component 102 can transmit information to the entertainment medium 104 or receive information from the entertainment medium 104 either directly or indirectly, which is described in greater detail infra.

The entertainment medium 104 can be substantially any suitable device, architecture, platform, etc. that provides entertainment content 106, such as entertainment content 106 included in the entertainment medium 104 that is intended to be viewed, manipulated, or otherwise consumed by an end-user for the purpose of providing entertainment value. For example, the entertainment medium 104 can be, e.g., a television or other display device, potentially including associated electronics or controllers (either hardware or software) including connected game stations or media controllers as well as peripherals such as output devices (e.g., the display or speakers) and/or input devices (e.g., a remote control, keypad, menus). In accordance therewith, the entertainment content 106 can be audio-visual material (e.g., video games, multimedia, prerecorded content) suitable for use with the television or other device.

The entertainment medium 104 can also be or can include a compact disc (CD) or digital versatile disc (DVD) or other optical media, as well as other computer-readable media. Furthermore, the entertainment medium 104 can be or can include a CD or DVD player as well as computer-readable instructions included in the CD or DVD. Likewise, the entertainment content 106 such as music, a movie, games, and so on can be stored on the CD or DVD.

As another example, the entertainment medium 104 can be a toy or game, including but not limited to a handheld device (e.g., an e-book reader, an electronic game, a cellular phone . . . ), a board game, and so forth. Hence, the entertainment content 106 can be a procedure, an objective, a learning tool, or substantially any suitable content that facilitates some form of entertainment value. It is to be appreciated that many other types of entertainment mediums can exist and can be considered tot be within the scope of the subject claims such as a rollercoaster, printed media, an arcade game, or even games that teach transferable skills such as dancing, karate, driving, orienteering, or games that relate to improving haptics such as touch or reflexes.

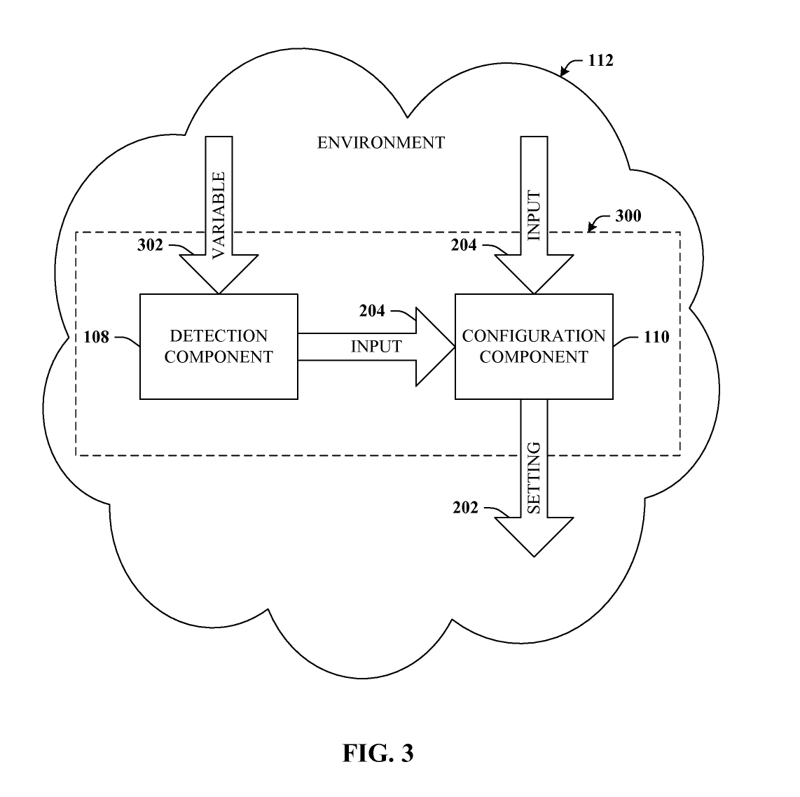

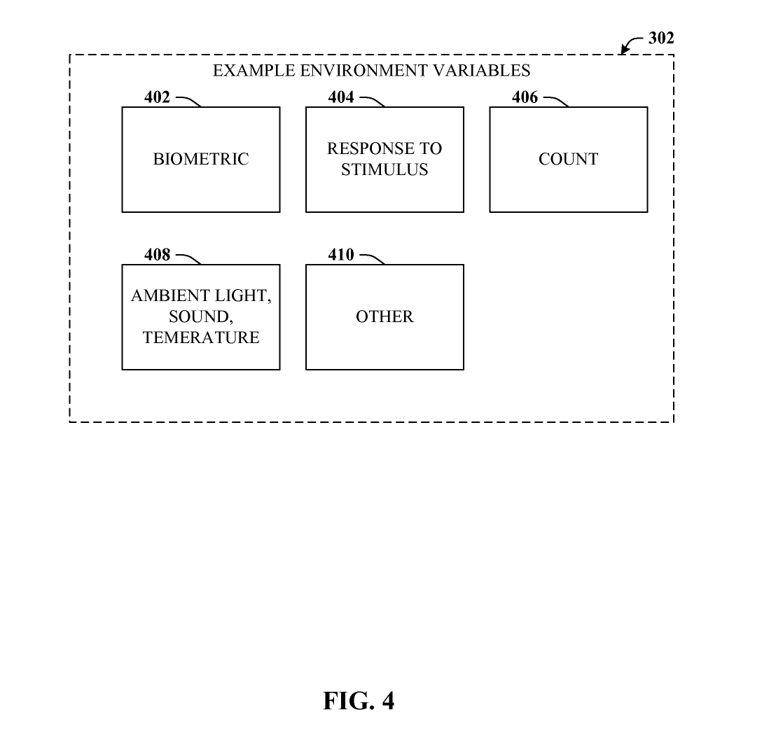

The system 100 can also include a detection component 108 that can obtain an environment variable (not shown), wherein the environment variable can be associated with an environment 112. Further discussion with respect to environment variables can be found with reference to FIGS. 3 and 4 and the associated text infra. In accordance with an aspect of the claimed subject matter, the environment 112 can be defined by an association with consumption of the entertainment content 106. For example, the entertainment medium 104 can facilitate some manner of entertainment value by providing (e.g. including, outputting, conveying, transmitting) the entertainment content 106. The environment 112 can thus be defined in some cases as a physical region within an area of effect of the entertainment medium 104 or an area in which the content 106 can potentially be consumed. One suitable example is a typical living room (e.g., environment 112) in which a television (e.g., entertainment medium 104) is displaying a feature film (e.g., entertainment content 106). In this case, the environment 112 can include the entire living room or virtually any region or space in which the content 106 can be consumed.

As another example, environment 112 can be defined as an area around the consumer of the entertainment content 106. For instance, consider a user of a media player listening to relaxing music by way of a set of headphones. The actual physical range in which the music can be consumed is quite small, however, the environment 112 can include more than just the region of space near the headphone speakers. Rather the environment 112 can be a region around the user, including the user (e.g., the environment of the consumer of content 106). Thus, if the user of the headphones is in the same living room discussed supra, the environment 112 can be as large (or even larger) than the environment 112 associated with the television, even though the television can provide a greater area of effect for potential consumption of the entertainment content 106 than can a set of headphone speakers. Such cases can exist since the former is defined by an environment of a user consuming the content 106, whereas the latter is defined by an area in which the content 106 can be consumed.

It is to be appreciated, however, that the environment 112 is not necessarily limited to a physical definition and many other suitable aspects can exist. For instance, the environment 112 can relate to metaphysical distances, relationships, as well as to objects or entities that are affected in some way, either directly or indirectly, by the entertainment medium 104, the entertainment content 106, and/or various other factors described below. Moreover, with the foregoing in mind, while the environment 112 typically includes the immediate vicinity of the consumption of the entertainment content 106, it is readily apparent that the environment 112 can also (but need not in all cases) encompass the entertainment medium 104 as well as all or portions of the system 100. Likewise, all or portions of the system 100 can be a component of the entertainment medium 104

As discussed, the detection component 108 can obtain an environment variable associated with the environment 112. It is to be appreciated that while the environment 112 can include the entertainment medium 104, the environment variable need not be related to the entertainment medium 104, yet in other situations a relationship can exist. For instance, returning to the example in which the entertainment medium 104 is a television and the environment 112 is the living room, typical environment variables in that case can be, e.g. a time of day, a temperature, or a number of persons in the living room (unrelated to the entertainment medium 104), a level of light or sound in the living room (related in part), or the fact that the television is turned on at the moment (directly related). Additional aspects associated with the detection component 108 and/or environment variables can be found in connection with FIGS. 3 and 4.

In addition to the content component 106 and the detection component 108 previously introduced, the system 100 can also include a configuration component 110. The configuration component 110 can receive an input from one or both of the content component 102 or the detection component 108. Based at least in part upon the received input, the configuration component 110 can determine an interactive setting. Additionally, potentially depending upon the type of input received, the nature of the interactive setting, as well as numerous other factors, the configuration component 110 can facilitate application of the interactive setting to the entertainment medium 104, the entertainment content 106, or to the environment 112.

Further details and a number of illustrations are provided herein, however, as a brief introduction, the interactive setting can be employed to change an entertainment experience associated with consumption of entertainment content 106. For example, conventional entertainment content such as a movie or music is delivered sequentially, or in other cases such as with a video game, provided according to parameters that relate solely to volitional user input to the video game. Thus, conventional entertainment content has no means for tailoring content based upon an associated environment 112 and/or based upon non-volitional or involuntary (but potentially important) user input. However, in accordance with an aspect of the claimed subject matter, the interactive setting can be applied to the entertainment medium 104, entertainment content 106, or environment components (described infra). As a result, an entertainment experience can be dynamically tailored based upon personalized and real-time data.

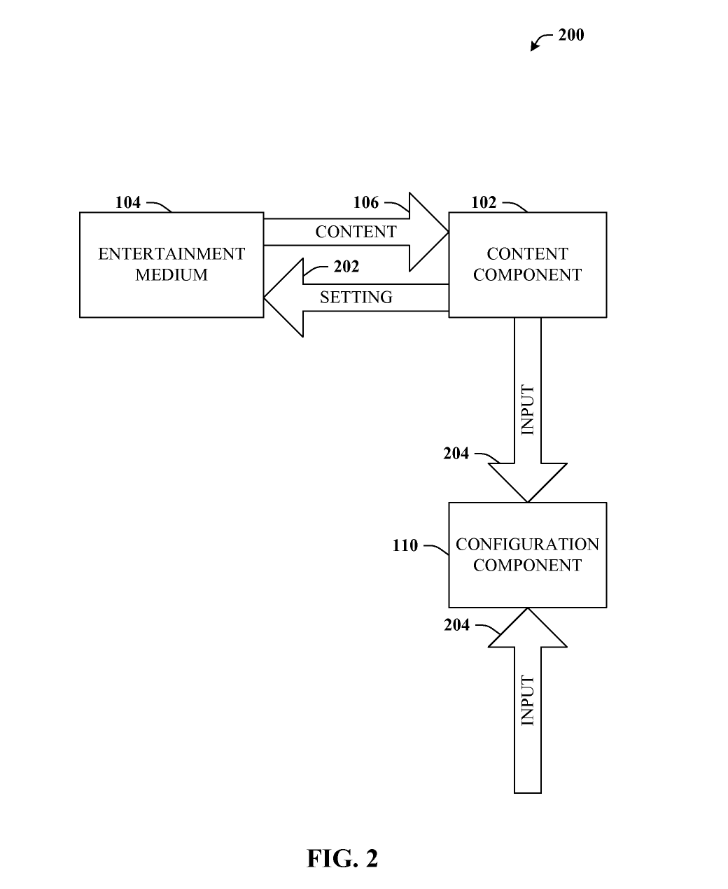

Turning now to FIG. 2, additional aspects are detailed with respect to the content component 102. FIG. 2 illustrates a system 200 that can update the entertainment medium 104 to facilitate an enhanced entertainment experience. In general, the system 200 can include the content component 102 that can communicate with the entertainment medium 104. The system 200 can also include the configuration component 110 that can dynamically determine an interactive setting 202 based upon inputs 204. Typically, the input 204 can be received from the detection component 108 (further detailed in connection with FIG. 3) based upon, e.g., environment variables. Additionally or alternatively, the input 204 can also be received from the content component 102 based upon, e.g., an instruction from or an examination of the entertainment medium 104 or the entertainment content 106.

For example, an interactive setting 202 can be based at least in part upon a genre, style, type, event, setting, or mood indicated, determined, or inferred from the entertainment content 106. Likewise, the interactive setting 202 can be based upon a command, query, or instruction from the entertainment medium 104. For example, the author of the entertainment content 106 may desire to create a romantic theme, mood or setting for a movie. Thus, in conjunction with conventional means of setting a romantic mood (swelling music, realistic acting, direction, cinematography, excellent script, dialogue, character development, etc.), the entertainment content 106 can include an instruction to, say, dim the lights, ignite the fireplace, or the like. This instruction can be received as input 204 and subsequently employed to create an interactive setting 202 that can be provided to an environment component (not shown) such as, in this case, a lamp or a fireplace.

In accordance with another aspect, the instruction from the entertainment content 106 (or entertainment medium 104) can be directed to a query or request, such as a request to apply a suitable interactive setting 202. Again, such a request can be received as input 204 and employed, potentially along with other input 204, to determine the suitable interactive settings 202. For example, the request can be a simple query such as should the romantic ending to this movie be delivered or should the comic ending be supplied? Or did the user laugh at the last one-liner?, etc. These and other queries/instructions can be answered based upon input 204 received as environment variables (e.g., was there laughter at a particular time stamp, are the lights dim and/or the fireplace on, are their exactly two people in the room, and so on).

Further yet, the interactive setting 202 can be intelligently inferred, even without an explicit instruction from the medium 104 or content 106. It is to be appreciated that in accordance with an aspect of the claimed subject matter, the entertainment content 106 included in the entertainment medium 104 can be interactively configurable in accordance with an interactive setting 202. As such, when particular input 204 is received, an interactive setting 202 can be created and applied. For example, the configuration component 110 can determine or infer that the entertainment content 106 intends to create a romantic setting (e.g., analysis of sound or music, key words, geometrical relationships or patterns between actors . . . ), or, alternatively when a consumer desires a romantic setting (e.g., analysis of ambient lighting, quantity of consumers in the environment, relationships between the consumers . . . ). In either case, the effect can be enhanced by, e.g. applying an interactive setting 202 to the appropriate entity.

For instance, in cases in which it is determined or inferred that the content intends to produce a particular effect, the configuration component 110 can generate interactive settings 202 applicable to components in the environment to facilitate or enhance the intended effect. Similarly, when it is determined that a consumer desires or positively responds to a certain effect, the configuration component 110 can create interactive settings 202 and apply these to the entertainment content 106 (e.g., apply the romantic mood settings to the content 106), or to suitable environment components (e.g., automatically pause and/or mute when the telephone rings for a certain type of entertainment consumption versus automatically turn off ringer during for another type).

It is to be appreciated that the configuration component 110 can employ a wide variety of data or data sets to facilitate numerous determinations and/or inferences such as content templates, content consumer identification, history, demographics, profiles, data stores related to keywords, statistics, or stochastic data, etc. In particular, the configuration component 110 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

Referring now to FIG. 3, additional aspects are detailed with respect to the detection component 108. FIG. 3 illustrates a system 300 that can monitor and update the environment 112 to facilitate an enhanced entertainment experience. It is to be appreciated that the system 300 can reside in the environment 112 as depicted, however, it is to be understood that portions of the system 300 can be remote from the environment 112 as well. Generally, the system 300 can include the detection component 108 that can obtain an environment variable 302 associated with the environment 112. The environment variable 302 typically relates to an aspect, feature, and/or condition of the environment 112, examples of which are provided with reference to FIG. 4.

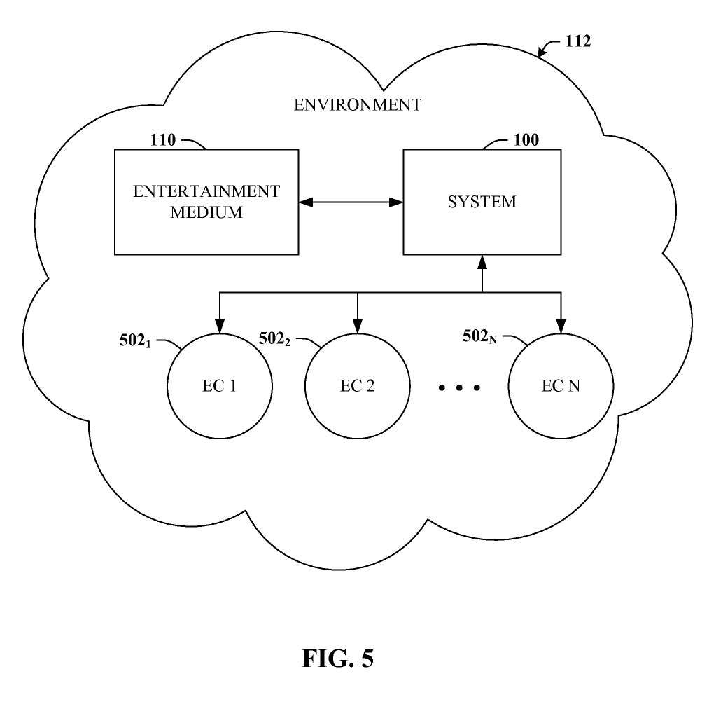

Accordingly, the detection component 108 can include and/or can be operatively or communicatively coupled to a wide array of sensors extant in the environment 112. Upon receipt of the environment variable 302, the detection component 108 can transmit input 204 to the configuration component 110, wherein the input 204 can be based upon the environment variable 302. The configuration component 110 can receive the input 204 from the detection component 108 as well as other input 204 such as from the content component 102 detailed supra. Based upon either or both types of input 204, the configuration component 110 can dynamically determine an interactive setting 202 and, as well, can apply the interactive setting 202 to suitable component such as to the entertainment medium or content, or to the environment 112 or components (further described in connection with FIG. 5) thereof.

Turning briefly to FIG. 4, a graphical representation of various exemplary environment variables 302 is illustrated. Appreciably, the enumerated environment variables 302 are intended to be exemplary in nature, but not necessarily intended to limit the scope of the appended claims to only the provided examples. Rather, many additional environment variables 302 can exist and can be suitable subject matter for what is claimed. An initial example environment variable 302 can be a biometric 402. The biometric 402, which can be, e.g. a heart rate, thermogram, brainwave pattern, sweat, gaze or other indicia of attention or focus, blinking or other reflexive indicia, posture or sitting location (e.g., erect on the edge of the seat versus relaxed or fidgety), grip tension, dozing, or other indicia of excitement versus boredom, and so on can be an excellent source of information regarding the effects of consumed entertainment content upon the consumer. For example, an increased heart rate during what a content author hopes is a particularly riveting action sequence of a movie or video game scenario or sequence can be indicative of a successful effect. Accordingly, later content can be tailored appropriately to enhance this and other effects based upon the biometric 402 feedback.

Typically, the biometric 402 relates to a consumer of the entertainment content, however, it should be noted that the biometric 402 can relate to other entities within the environment as well. In addition, the biometric 402 can also be indicative of an identification of the consumer, which can facilitate additional opportunities for tailoring and/or enhancing the entertainment experience. For example, identifying the content consumer can allow for or simplify the use of profiling and other uses of historical data, demographics or the like to further tailor or enrich an entertainment experience.

Another example environment variable 302 can be a response 404 to a stimulus. For example, laughter at a comic situation in a movie or a yelp when the monster appears out of nowhere in a video game can be common responses. It is to be understood that various categories can exists as well to further refine the response. For instance, a dry chuckle can be distinguished from hearty laughter. Moreover, it is to be noted that all environment variables 302 can include time stamp information, which can be useful for comparison purposes. Ordinarily, the stimulus will be provided by the entertainment medium and/or entertainment content, however, it should be understood that in some cases the stimulus can originate from the environment as well.

A third type of example environment variable 302 can be a count 406 of objects and/or entities of a particular type in the environment, such as the count 406 of consumers of the content or the count of persons in the environment (even if they are not consumers of the content). Entertainment can be notably tailored based upon such information. For example, a game (or other type of entertainment) can be configured differently based upon the count 406.

A fourth example of an environment variable 302 can be environmental factors such as ambient conditions 408. Ambient conditions 408 can relate to light, sound, temperature, local time, etc., and can provide useful feedback for personalizing entertainment content, especially in areas relating to themes or moods. It is readily apparent that many other 410 types of environment variables can exist and can be within the spirit and scope of the claimed subject matter. For instance, an environment variable 302 can be a location and/or trajectory of a content consumer. Consider a theme park that issues ID badges to patrons (e.g., content consumers) as the patrons arrive at the theme park. The badges can include Radio Frequency Identification (RFID) and/or other wireless technologies to monitor location or trajectory of the patron. Various cameras throughout the theme park can continually image the environment, and when the patron leaves for the day, returning the ID badge, the images that include the patron at the top of a rollercoaster, eating an ice cream cone, etc. can be quickly selected, filtered, or aggregated and provided to the patron.

Another potential example environment variable 302 can be a perspective of the content consumer (e.g., a point-of-view or focus of the content consumer). For example, the entertainment medium can be a holodeck with multiple display screens. Content for each screen can activate, pause, or update based upon the focus or perspective of the content consumer. In addition, the example environment variable 302 can relate to configurations or activity associated with devices or components of the environment (generally components that are unrelated, not associated, and/or disparate from the entertainment medium), which is further detailed in view of FIG. 5. It is of course impossible to describe every example or scenario that can be employed in connection with the claimed subject matter. Thus, the examples given herein are intended to provide context, but are not intended to limit the scope of the claims to exclude other examples.

Turning now to FIG. 5, an example environment 112 is depicted. In general, the environment 112 can include the system 100 described supra as well as the entertainment medium 104 (which can include and/or provide entertainment content). It is to be appreciated that other configurations or topologies can exist. For example, the system 100, or portions of the system 100 (e.g., the configuration component) can be remote from the environment 112. Regardless, the entertainment component 104 typically outputs or conveys entertainment content to the environment 112 as well as to the system 100 (e.g., by way of the content component).

In addition the environment 112 can also include substantially any number, N, of environment components 502₁-502_{N}, which can be referred to herein either individually or collectively as environment components 502. Generally, environment components relate to objects, entities, devices, and so on that are extant in the environment. 112. Furthermore, in accordance with an aspect of the claimed subject matter, the environment components 502 can be interactively configurable based upon an interactive setting (e.g., the interactive setting 202 from FIG. 3). Hence, in response to an input (e.g., input 202 from FIG. 2 or 3) that can be derived from the entertainment medium 104 or the environment 112, the system 100 (e.g., configuration component 110) can determine an interactive setting and apply the setting an environment component 502.

Numerous examples of environment components 502 have been previously mentioned in scenarios above, but for the sake of thoroughness, these scenarios can be revisited. According to one aspect, the environment component 502 can be interactively configured based upon instructions from the entertainment medium 104. For example, a movie can transmit an instruction indicating that a romantic mood is intended, or a video game can transmit an instruction indicating that a tense or frightening event is imminent. In another aspect, the desired effect can be inferred based upon an examination of the content being consumed, for example. In any case, an interactive setting can be created for the purpose of enhancing, enriching, or facilitating the desired effect, and in accordance therewith the interactive setting can be applied to the environment component 502. Thus, a lamp (e.g., environment component 502) can be dimmed or switched off (e.g., applying the interactive setting) in order to promote the desired effect (e.g., promoting a romantic mood or tense setting).

While the entertainment medium 104 can be a device extant in the environment 112, it is to be appreciated that the in accordance with an aspect of the claimed subject matter, the entertainment medium 104 does not constitute an environment component 502. Rather, the entertainment medium 104 is intended to be exclusive of the environment components 502, particularly, when the entertainment medium 104 is providing the content being consumed.

Moreover, while interactive settings applied to the entertainment component 104 are typically based upon environment variables, the reverse need not always be the case. In particular, interactive settings applied to an environment component 502 can be, but not need be, derived from the entertainment medium 104. Instead, the interactive settings applied to an environment component 502 can also be derived from environment variables, just as interactive settings applied to the entertainment medium typically are. Thus, interactive settings can be employed in a wide variety of ways such as, e.g., applying a setting to the entertainment medium 104 based upon an environment variable (e.g., pausing and/or muting a television program when a telephone rings); applying a setting to an environment component 502 based upon an input from the entertainment medium 104 (e.g., dimming a lamp to promote an effect indicated by or inferred from the television program); or applying a setting to an environment component 502 based upon an environment variable (e.g. switching the lamp back on when a doorbell rings).

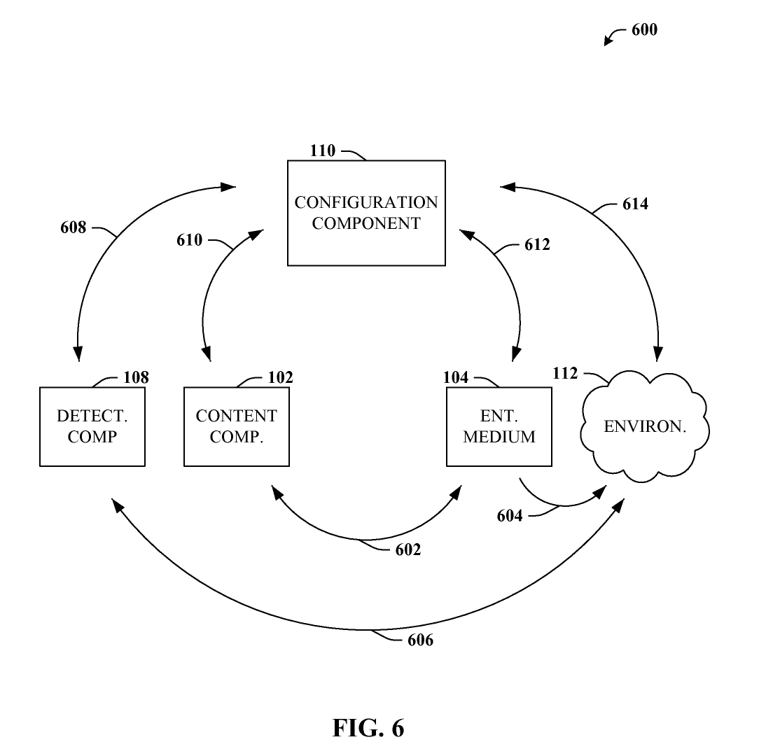

Referring now to FIG. 6, a system 600 that illustrates exemplary relationships and/or information paths is depicted. The system 600 can include the content component 102, the entertainment medium 104, the detection component 108, the configuration component 110, and the environment 112, as substantially described supra. Generally, the entertainment medium 104 can output or broadcast the entertainment content to the environment (depicted by path 602), where the content can be consumed, and wherein in some cases the scope of the environment 112 can be defined. In many situations, the medium 104 does not receive information directly from the environment 112, hence, path 602 is illustrated as a one-way path. The content component 102 can also receive the entertainment content (depicted by path 604) or instructions or queries from the entertainment medium 104, and can also in some cases apply an interactive setting to the entertainment medium 104. It is to be appreciated that one or both of the latter two features can be additionally or alternatively handled by the configuration component 110 by way of path 612.

The detection component 108 can monitor the environment and can thus receive this data along path 606. While not expressly necessary, generally, the detection component 108 includes passive sensors aimed at collection of data, so path 606 is depicted here as a one-way path. In such cases, information supplied to the environment or environment components can be transmitted by the configuration component 110 by way of path 614. Paths 608 and 610 can provide necessary communication channels between the configuration component 110 and one of the detection component 108 and the content component 102. One noteworthy example is the input (e.g., input 202 from FIGS. 2 and 3, respectively), which can be employed by the configuration component 110 to generate an interactive setting that can be applied to the entertainment medium 104 or to the components of the environment 112 by way of paths 612 and 614, respectively.

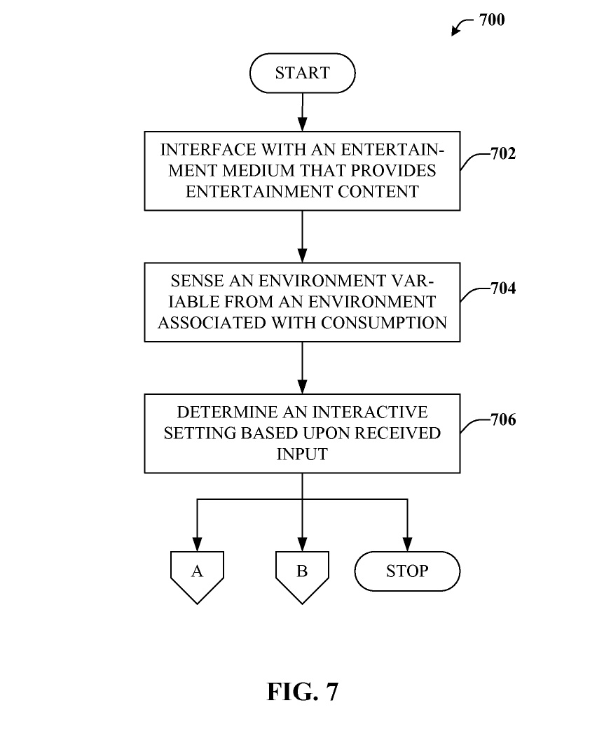

FIGS. 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 7, an exemplary method 700 for facilitating an enhanced entertainment experience based upon interactivity between an entertainment medium and an environment is depicted. In general, at reference numeral 702, an entertainment medium that includes entertainment content can be interfaced with. In particular, the entertainment content can be received as can instructions or queries from one or both of the entertainment medium or the entertainment content. Furthermore, interactive settings can be applied to one or both of the entertainment medium or the entertainment content.

At reference numeral 704, an environment variable can be sensed or detected from an environment, wherein the environment is associated with consumption of the entertainment content. At reference numeral 706, an interactive setting can be determined or inferred based upon input received from at least one of the entertainment medium, the entertainment content, or the environment. Accordingly, the input can be based upon instructions or queries, as well as determinations or inferences that relate to information received from the entertainment medium or the entertainment content. In addition, the input can be based upon environment variables detected or received from the environment or environment components.

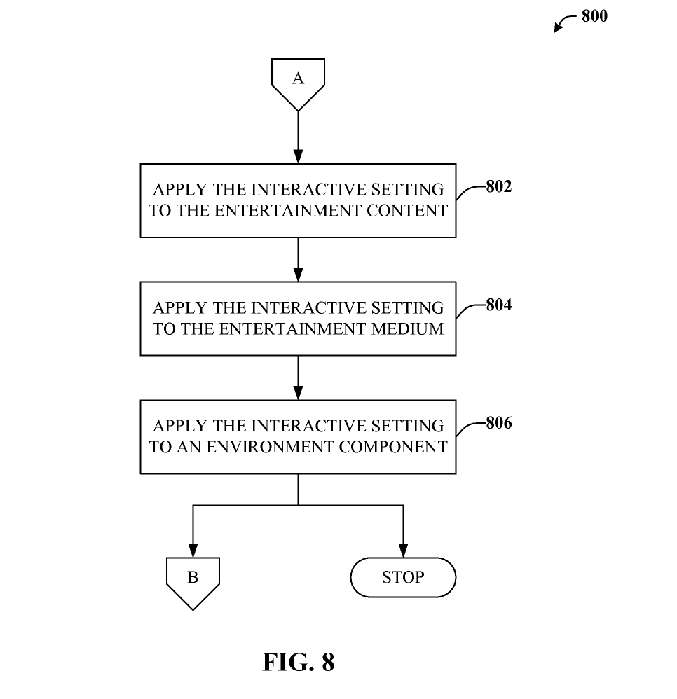

FIG. 8 is an exemplary method 800 for applying an interactive setting employed for facilitating an enhanced entertainment experience. At reference numeral 802, the interactive setting (e.g., the interactive setting determined at act 706 of FIG. 7) can be applied to the entertainment content. For example, the entertainment content can be dynamically selected and/or selectively tailored based upon various interactive settings, which can be, in turn, based upon any number of environment variables. Hence, alternative endings or additional or supplemental content can be selected for movies, games, or other forms of entertainment.

At reference numeral 804, the interactive setting can be applied to the entertainment medium. For example, interactive settings described at act 802 can be first provided to the entertainment medium, which can manage or control the interactive settings to be implemented. In addition, the interactive setting can apply to the entertainment medium itself rather than the content, such as a volume level that is reduced based upon an environment variable such as a telephone or doorbell ring. At reference numeral 806, the interactive setting can be applied to an environment component apart from either the entertainment medium or content. It is to be appreciated that the environment component can be substantially any element, object, or entity in the environment (but generally excludes the entertainment medium) that is adapted to be interactively configurable based upon interactive settings.

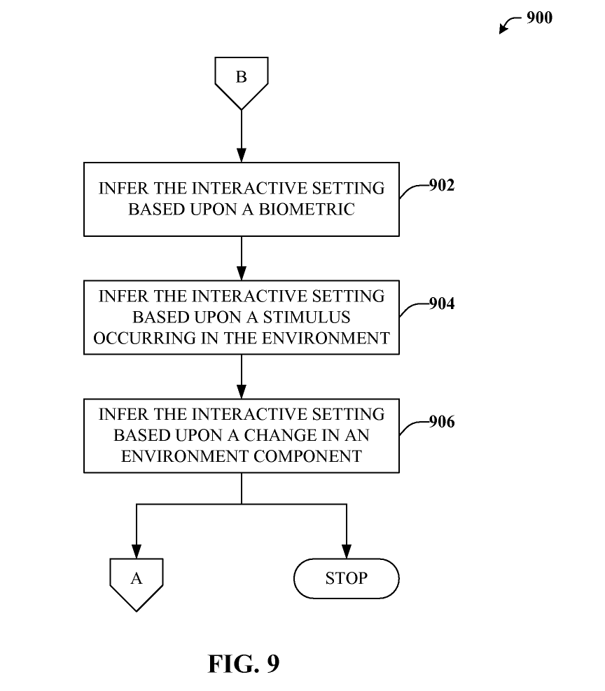

Turning now to FIG. 9, an exemplary method 900 for inferring interactive settings employed for facilitating an enhanced entertainment experience is depicted. At reference numeral 902, the interactive setting can be inferred based upon a biometric. For example, entertainment content, the entertainment device, or even environment components can be dynamically configured with an interactive setting that is inferred based upon a biometric of a consumer of the entertainment content. Accordingly a variety of potential feedback with respect to the effect of the content consumption can be detected and employed to, inter alia, enhance the entertainment experience.

At reference numeral 904, the interactive setting can be inferred based upon a stimulus occurring in the environment. Typically, the stimulus relates to a feature of the entertainment content or medium, however, in some cases the stimulus can originate with an environment component. At reference numeral 906, the interactive setting can be inferred based upon a change occurring in an environment component.

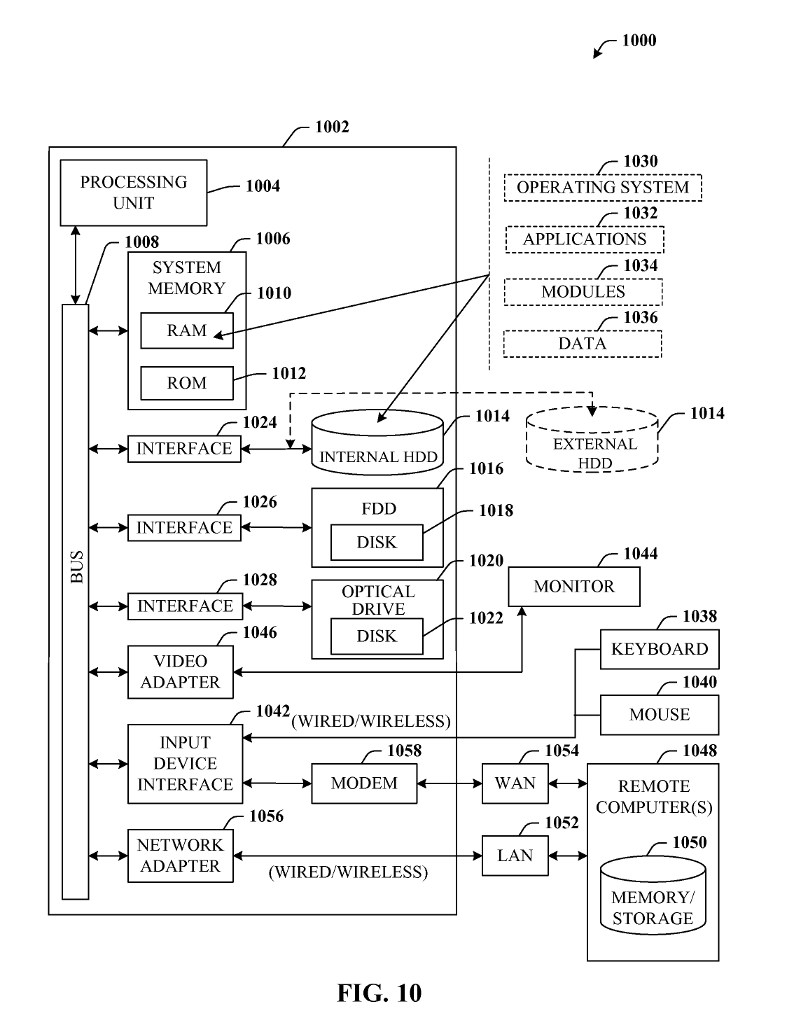

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above can be implemented in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the claimed subject matter.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g. a wide area network (WAN) 1054. Such LAN and WAN networking environments are commonplace in offices and companies, and facilitate enterprise-wide computer networks, such as intranets, all of which may connect to a global communications network, e.g. the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 10 Mbps (802.11a) or 54 Mbps (802.11b) data rate, for example, or with products that contain both bands (dual band), so the networks can provide real-world performance similar to the basic 10BaseT wired Ethernet networks used in many offices.

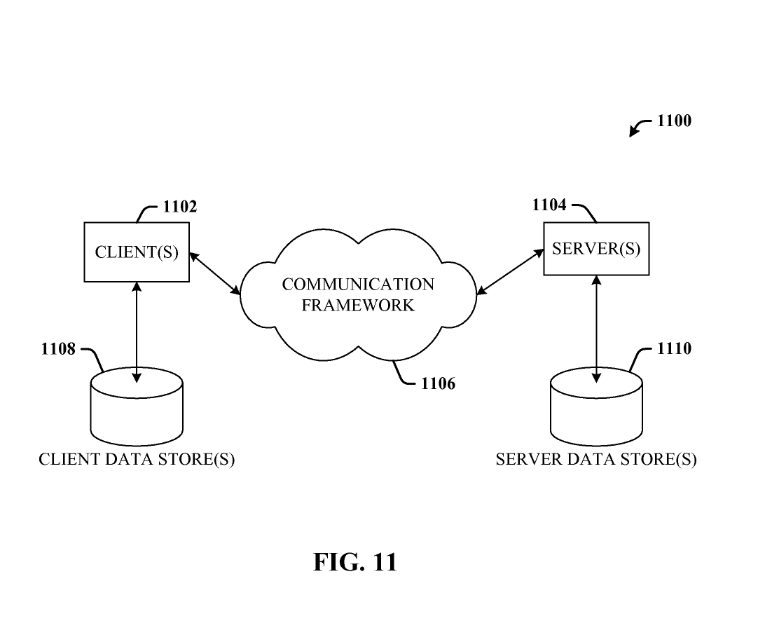

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates an enhanced entertainment experience based upon interactivity between an entertainment medium and an environment, comprising:
a content component that communicates with an entertainment medium, the entertainment medium includes entertainment content;
a detection component that obtains an environment variable associated with an environment; and
a configuration component that receives an input from the content component or the detection component and dynamically determines an interactive setting based upon the input.

2. The system of claim 1, the entertainment content is interactively configurable in accordance with the interactive setting.

3. The system of claim 2, the input is based upon the environment variable obtained by the detection component.

4. The system of claim 1, the content component applies the interactive setting to at least one of the entertainment medium or the entertainment content.

5. The system of claim 1, the environment is associated with consumption of the entertainment content.

6. The system of claim 1, the environment includes the content component.

7. The system of claim 1, the environment includes an environment component that is interactively configurable in accordance with the interactive setting.

8. The system of claim 7, the input is based upon the environment variable obtained by the detection component.

9. The system of claim 7, the input is an instruction from the entertainment medium or the entertainment content communicated to the content component.

10. The system of claim 7, the configuration component applies the interactive setting to the environment component.

11. The system of claim 7, the environment component is exclusive of the entertainment medium.

12. The system of claim 1, the configuration component intelligently infers the interactive setting based at least in part upon historical data.

13. The system of claim 1, the environment variable is a biometric associated with a consumer of the entertainment content, the consumer is extant in the environment.

14. The system of claim 1, the environment variable is a response to a stimulus provided by at least one of the entertainment medium or the entertainment content.

15. The system of claim 1, the environment variable is a count of a number of consumers of the entertainment content, the consumers are extant in the environment.

16. The system of claim 1, the environment variable is a brightness level extant in the environment.

17. A method for facilitating an enhanced entertainment experience based upon interactivity between an entertainment medium and an environment, comprising:
interfacing with an entertainment medium that provides entertainment content;
sensing an environment variable from an environment associated with consumption of the entertainment content; and
determining an interactive setting based upon receiving data from at least one of the entertainment medium, the entertainment content, or the environment.

18. The method of claim 17, further comprising at least one of the following acts:
applying the interactive setting to the entertainment content;
applying the interactive setting to the entertainment medium; or
applying the interactive setting to an environment component.

19. The method of claim 17, further comprising at least one of the following acts:
inferring the interactive setting based upon a biometric;
inferring the interactive setting based upon a stimulus occurring in the environment; or
inferring the interactive setting based upon a change occurring in an environment component.

20. A system for obtaining feedback from an entertainment consumption environment for enhancing an entertainment experience, comprising:
means for communicating with an entertainment medium, the entertainment medium including entertainment content;
means for obtaining an environment variable from an environment associated with consumption of the entertainment content; and
means for ascertaining an interactive setting in accordance with data received from at least one of the entertainment medium, the entertainment content, or the environment.
